(19) United States
(12) Patent Application Publication
(10) Pub. No.: US 2023/0252337 A1
(43) Pub. Date: Aug. 10, 2023

(54) SYSTEMS AND METHODS FOR GENERATING PROCESSABLE DATA FOR MACHINE LEARNING APPLICATIONS

(71) Applicant: Rima Al Shikh, Halifax (CA)

(72) Inventor: Rima Al Shikh, Halifax (CA)

(21) Appl. No.: 17/592,904

(22) Filed: Feb. 4, 2022

(51) Int. Cl. G06N 20/00; G06K 9/62

(52) U.S. Cl. CPC G06N 20/00; G06K 9/6215; G06K 9/6248; G06K 9/6256

(57) ABSTRACT

Systems and methods for converting distributed raw user data into processable data for data analysis, such as machine learning (ML) training or the like. In one embodiment, the method comprises generating, at a server, from a data schema comprising one or more data types, an instruction schema comprising, for each data type in said one or more data types, one or more instructions to be applied to the data type; for each device in a plurality of devices communicatively coupled to said server: sending, from the server, to the device, the instruction schema; receiving, at the device, the instruction schema; applying, at the device, each instruction in the instruction schema on locally stored raw user data, so as to generate an embedding of processable data; sending, from the device, to the server, the embedding; and receiving, at said server, the embedding from each device.

### FIELD OF THE INVENTION

The present disclosure relates to machine learning, more specifically, but not by way of limitation, more particularly to systems and methods for generating processable data for machine learning applications.

### BACKGROUND

Traditional training of machine learning algorithms entails copying user data from devices where data is generated to cloud computers that store and process the data. Not only does this put user data at risk of being compromised during transit or storage, but it is also challenging and expensive to build for most enterprises.

There has been a rise of techniques that attempt to solve for user privacy, as well as complexity, of such a setup. This complexity hinders the progress of the machine learning field, slows its adaption by enterprises, and makes it very costly and time-consuming to run experiments.

Federated learning solves these challenges by allowing for a model to train in a distributed fashion, whereby devices that originally generated the data can participate in training a global machine learning model by training locally on the data it itself generated. While this approach has proven effective in scenarios where data is balanced between participating devices, and each device has a sufficient volume of data to contribute meaningful learning to the global model; this approach has proven ineffective in imbalanced data situations and in situations where the device might only have one data record. For example: a) A device only containing a single user profile with a global model objective to classify that profile's owner as human or bot; or b) a device containing a single sentence, with an objective of identifying if that sentence is humorous. It is not possible in such cases to train a machine learning model on one data record, as this record does not provide variety or meaning to a learning model to be inferred.

Building upon the research done in the area of federated machine learning and decentralized computing, this disclosure provides a practical solution to achieve the objective of protecting data privacy and significantly reducing the complexity of machine learning systems.

### SUMMARY

The following presents a simplified summary of the general inventive concept(s) described herein to provide a basic understanding of some aspects of the disclosure. This summary is not an extensive overview of the disclosure. It is not intended to restrict key or critical elements of the embodiments of the disclosure or to delineate their scope beyond that which is explicitly or implicitly described by the following description and claims.

A need exists for systems and methods for generating processable data from distributed raw user data for use in machine learning (ML) applications.

In accordance with one aspect, there is presented a computer-implemented method for automatically converting raw user data into processable data for data analysis: generating, at a server, from a data schema comprising one or more data types, an instruction schema comprising, for each data type in said one or more data types, one or more instructions to be applied to the data type; for each device in a plurality of devices communicatively coupled to said server: sending, from the server, to the device, the instruction schema; receiving, at the device, the instruction schema; applying, at the device, each instruction in the instruction schema on locally stored raw user data, so as to generate an embedding of processable data; sending, from the device, to the server, the embedding; and receiving, at said server, the embedding from each device.

In one embodiment, each instruction comprises one or more additional parameters required to apply the instruction on the data type.

In one embodiment, the applying comprises the steps of: executing an executable function corresponding to said instruction using the one or more parameters on said locally stored raw user data; and adding an output of said executable function to the embedding.

In one embodiment, the method further comprises the step of, before said executing: identifying, on a memory of the device, the executable function corresponding to the instruction.

In one embodiment, the instruction comprises the executable function to be executed.

In one embodiment, the one or more labels are appended to the embedding by the device.

In one embodiment, at least two of said one or more instructions are chain instructions, wherein each of the chain instructions are to be applied in a sequence, and wherein an output of a given chain instruction is used as an input for the next chain instruction in the sequence, and wherein the final chain instruction in the sequence generates the embedding.

In one embodiment, a plurality of embeddings is generated by said chain instructions and wherein the final chain instruction is directed to averaging the corresponding data types in said plurality of embeddings.

In one embodiment, the method further comprises the step of: performing, on said server, a data analysis task on the processable data of said received embedding.

In one embodiment, at least some of said instructions are directed to reducing the accuracy of the raw user data so as to render it more difficult to extract private information therefrom.

In one embodiment, the data analysis task comprises a clustering analysis or similarity testing.

In one embodiment, the data analysis task is a machine learning training task.

In one embodiment, the machine learning training task uses at least one of: supervised learning or unsupervised learning.

In one embodiment, the training task is only performed every time a designated number of embeddings are received from the one or more devices.

In one embodiment, a previous training task is resumed upon receiving another embedding.

In accordance with another aspect, there is provided a system for converting raw user data into processable data for data analysis, the system comprising: a server, the server comprising: a memory for storing a data schema comprising one or more data types; a networking module communicatively coupled to a network; a processor communicatively coupled to said memory and networking module, and operable to generate from the data schema an instruction schema comprising, for each data type in said one or more data types, one or more instructions to be applied to the data type; a plurality of devices, each comprising a memory, a networking module communicatively coupled to server via said network and a processor communicatively coupled to the memory and networking module, and operable to: receive, from the server via said network, the instruction schema; apply each instruction in the instruction schema on raw user data stored on said memory of said device, so as to generate an embedding of processable data; and send, to the server via said network, the embedding; and wherein the server is further configured to receive each embedding from the plurality of devices and store it in the memory of the server.

In one embodiment, each instruction comprises one or more additional parameters required to apply the instruction on the data type.

In one embodiment, each of said plurality of devices are each configured to apply each instruction by: executing an executable function corresponding to said instruction using the one or more parameters on said raw user data; and adding an output of said executable function to the embedding.

In one embodiment, the server is further configured to perform a machine learning training task on the processable data of said received embeddings.

In accordance with another aspect, there is provided a non-transitory computer-readable storage medium including instructions that, when processed by a device communicatively coupled to a server via a network, configure the device to perform the steps of: receiving, from the server via said network, an instruction schema comprising, for each data type in one or more data types of a data schema, one or more instructions to be applied to the data type; applying each instruction in the instruction schema on locally stored raw user data, so as to generate an embedding of processable data; sending to the server via said network, the embedding.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram of a system for generating processable data from distributed raw user data, in accordance with one embodiment.

FIGS. 2 and 3 are schematic diagrams illustrating examples of a data schema and an instruction schema, respectively, in accordance with one embodiment.

FIG. 4 is a process flow diagram illustrating a method for generating processable data from distributed raw user data, in accordance with one embodiment.

FIG. 5 is a schematic diagram illustrating certain method steps of the method of FIG. 4, in accordance with one embodiment.

FIG. 6 is a schematic diagram illustrating an example of raw user data, in accordance with one embodiment.

FIG. 7 is a process flow diagram illustrating an exemplary implementation of a method step of the method of FIG. 4, in accordance with one embodiment.

### DETAILED DESCRIPTION

The present disclosure is directed to systems and methods, in accordance with different embodiments, that provide a mechanism to generated processable data from raw user data locally on distributed networked devices where that raw user data is stored. The processable data has the form of a useful representation of the raw user data that may readily be used by a Machine Learning (ML) algorithm or the like trained on a remote server. By locally processing the raw user data on each networked device, and sending the processable data (e.g., data which may be used for further data analysis or ML processes) to the remote server, the storing and processing requirements on the server (i.e., in the cloud) itself are significantly reduced, thus allowing the server to focus on operating the final step of training the ML algorithm.

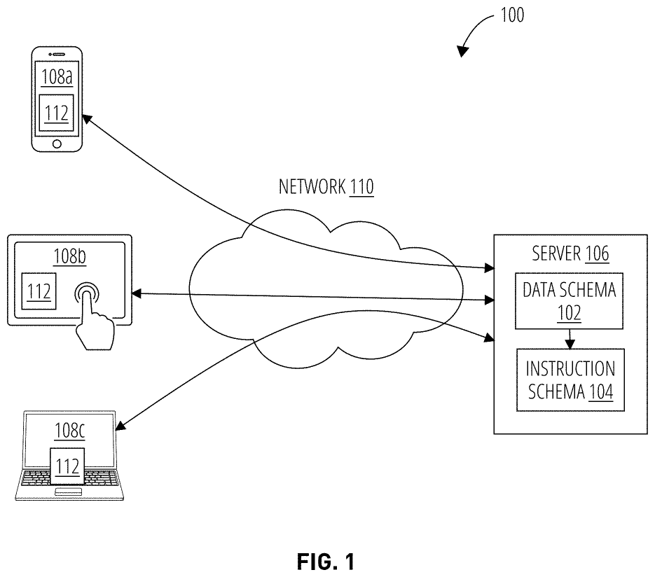

FIG. 1 is a schematic diagram of an exemplary system 100 comprising a server 106 and a plurality of user devices 104 (here illustrated as devices 108a-c as an example only) communicatively coupled to each other via a network 110. The user devices 104 may be any type of computing device known in the art, and my include, without limitation, personal computers, smartphones, tables, smartwatches, or the like. In some embodiments, the server 106 may be a single computer or a virtual server that is configured to offer software services remotely “in the cloud” to the devices 104. Each of the server 106 and devices 104 comprise a memory, a network adapter and a processor communicatively coupled to the memory and network adapter. Network 110 may be any type of public or private network, as long as it allows the devices 104 and the server 106 to exchange information. In some embodiments, devices 104 and server 106 may communicate via network 110 using one or more cryptographic process.

Server 106 usually comprises stored thereon a data schema 102, which is used, as will be explained below, to generate an instruction schema 104. The data schema 102 typically comprises a description of the data only, while the instruction schema 104 comprises instructions in the form of a series of operations that can be applied on the corresponding raw user data 112 generated by and stored on each of the devices 104.

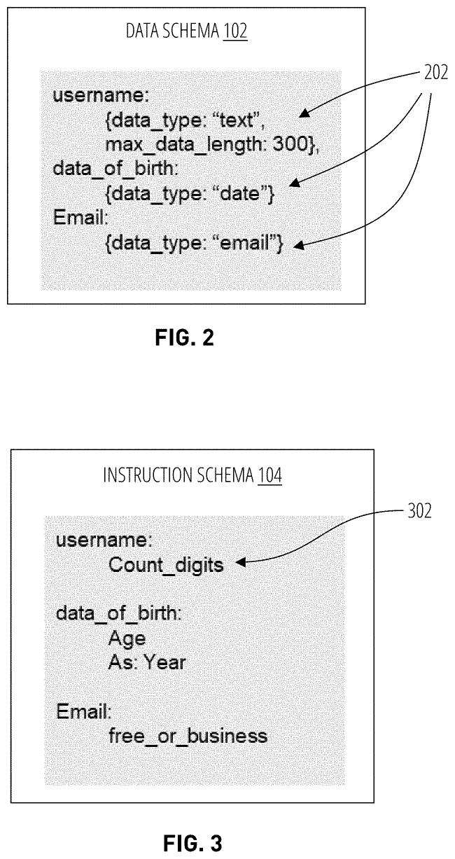

FIG. 2 shows an exemplary data schema 102, comprising three fields. The data types or descriptors 202 in the data schema 102, and other elements derived therefrom, are only an example used to discuss different embodiments of the present disclosure, and the skilled person in the art will appreciate that any number or type of data may be included into the data schema, without limitation.

FIG. 3 shows an example of the content of the instruction schema 104 corresponding to the data schema 102 of FIG. 2. For example, the instruction 302 generated based on the data type “text data” of the data schema 102 is “Count_digits” which counts the number of digits in a given text and returns the total.

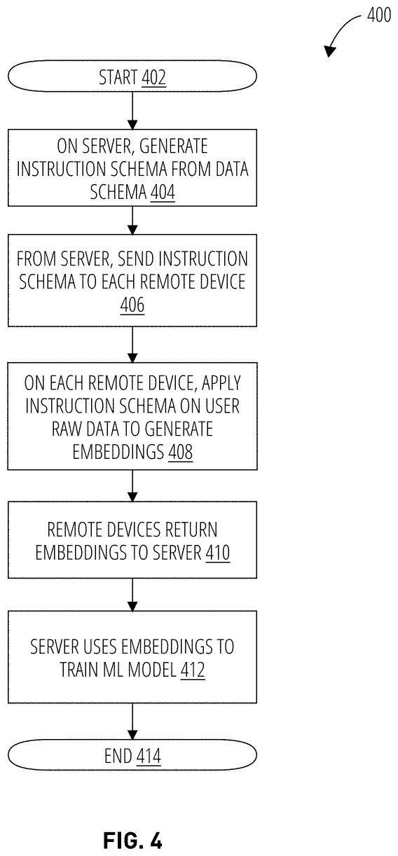

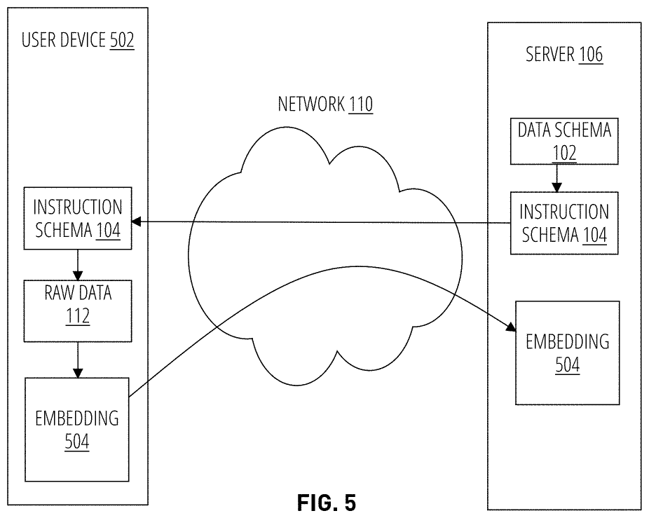

With reference to FIGS. 4 to 6, and in accordance with one exemplary embodiment, a method for generating processable data from raw data stored on user devices, generally referred by the numeral 400, will now be described. FIG. 5 is a schematic diagram used to illustrated the various method steps of FIG. 4. It shows an exemplary user device 502 in communication with the server 106. Method 400 start at step 402 and then proceeds to step 404, where the instruction schema 104 is generated on server 106 from the data schema 102 as explained above. At step 406, the instruction schema 104 is sent from the server 106 to each device connected thereto, here to user device 502. Notably, in some embodiments, the server 106 itself sends the instruction schema 104 to the user device 502, or in other embodiments, the user device 502 may request or pull the instruction schema 104 from the server 106. At step 408, each device (here user device 502) applies the instructions in the instruction schema 104 to the raw data 112 stored thereon to generate therefrom processable data in the form of an embedding 504.

In some embodiments, an embedding 504 is an array that is the result of executing all the instructions provided in the instruction schema 104 on their corresponding target elements in the raw data 112 stored on the user device 502. Hence, in some embodiments, the size of the embedding 504 is expected to be the size of the array in the instruction schema 104.

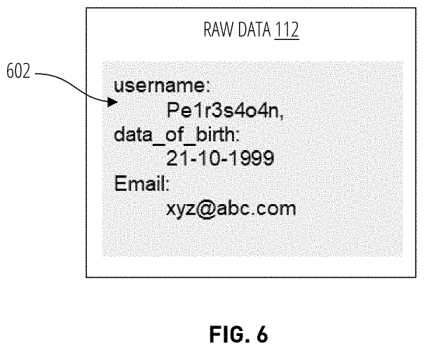

As illustrated in FIG. 3, an instruction schema 104 of array size 3 will result in an embedding 504 of size 3. Thus, in this example, and with reference to the exemplary raw data 112 of FIG. 6, the embedding 504 may look like [4, 22, 0], where first number in the array refers to the total number of digits in the username (for example a username 602 in the exemplary raw data 112 is “Pe1r3s4o4n”, which contains four digits), the second number in the embedding refers to the user's age (derived from the exemplary date of birth of “21-10-1999”), and the third number refers to the first categorical value of “personal” email address for the email address (e.g., the address “xyz@abc.com”).

In some embodiments, each instruction sent by the server 106 may comprise any additional parameters required to allow for the instruction to be fully performed. For example, the instruction “Age” might have parameters that allows “Age” to be calculated in “months” or “years”. As such, the age of 2 years is equal to 24 months; in this case, the instruction schema 104 will provide an additional parameter that specifies to the user devices 502 to calculate the age in months or years.

In some embodiments, the embedding 504 can be a higher-dimensional array, based on the complexity of instructions and their output, as well as a tensor.

In some embodiments, the instructions in the instruction schema 104 can be chained, where the output of one instruction can form the input to the next instruction. In such a case, the output of the final instruction in the chain takes place in the final embedding 504. For example, the instruction “Age” can be followed by an instruction that calculates which age group a user belongs to, so the output of “30” might be “3”, referring to the third age group.

At step 410, the embeddings 504 (from each device) are then sent back to the server 106, which in turn trains the target machine learning algorithm using the received embeddings at step 412. The system and method described herein may be used with any machine learning model known in the art. In addition, different machine learning training methods may also be used, without exception. For example, in some embodiments, the training task may rely on supervised or unsupervised learning methods or models. The method ends at step 414.

In some embodiments, if a label is required for training, each device 108 can append the labels to the embedding as the last number in the array.

In some embodiments, the ML training can be continuous and not require waiting for all devices to send their contributions to begin training. Training can happen at every batch of new embeddings received (for example whenever 500 new embeddings are received the training can commence starting from the last saved training or any checkpoint of the model desired).

In some embodiments, instructions can be improved over time on the same data set to improve the accuracy of the model and condense the embedding to useful information only. This can be done by applying feature importance techniques to analyze which instructions have been useful to the training of the model and which haven't.

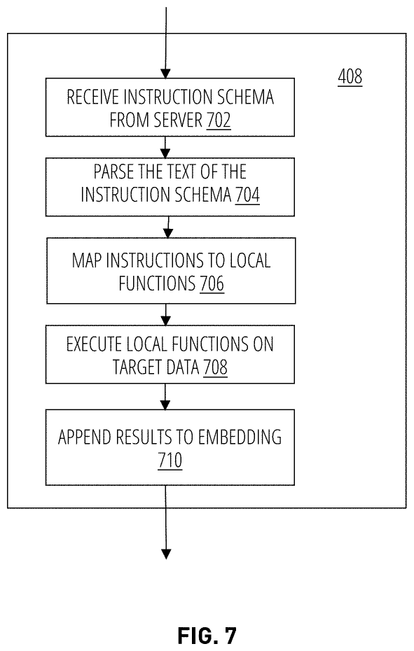

In some embodiments, the devices 108 receiving the instruction schema 104 will have a preprogrammed library (SDK) installed. This library can parse the instruction schema 104 and map it to preprogrammed instructions in the SDK. FIG. 7 shows an exemplary embodiment of method step 408 of method 400 discussed above. In it, at step 702, the device receives the instruction schema 104 from the server 106. At step 704, the device parses the instructions in the instruction schema 104, and at step 706 identifies a local function in the SDK that can execute this instruction. At step 708, the local function is applied with the data parameters specified in the instruction to the raw data 112 (if any) and the result is appended to the embedding 504 at step 710. For example, passing the username to the count digits function and generating the output of the function that is a numerical value and append this value to the embedding 404.

In some embodiments, instructions can be written in any format that is transmittable and parable by both the SDK and the server. Examples of those formats are XML, JSON, Binary, or plain text.

In some embodiments, instructions can be sent, as demonstrated in the example of FIGS. 4 and 7, as a definition of an instruction that the SDK can translate into a function. However, in some embodiments, the instructions may also be sent as an executable code transmitted over the network 110 that the SDK can execute. In some embodiments, the latter may require proofing work to ensure it is not misused to reveal private information about the data.

In some embodiments, instructions can be designed to ensure no private information can be parsed from the data by reducing its accuracy. For example, using “age group” instead of “age” or by decreasing the number of accurate features that may identify a user.

In some embodiments, chaining instructions allows for applying additional instructions on the overall embedding. For example, it is possible to average multiple embeddings generated by the schema on the device and in order to execute such instruction, the device must locally store versions of the embeddings. This case is particularly useful for scenarios where the embedding might be representative of a content the user of the device interacts with, and so for every content the user interacts with an embedding is generated and as such to produce one embedding that may represent the interactions of a user an instruction may average all the embeddings in one.

In some embodiments, it may be possible to use instructions to generate useful labels for the data, such as encoding the interactions a user may have with content on the device to act as labels for training of systems like recommender systems.

In some embodiments, the embeddings 504 may be further optimized or improved on the server 106.

In some embodiments, embeddings 504 generated can be used for other purposes than machine learning, such as performing clustering or similarity testing of such embeddings to identify closeness of certain data to other embeddings collected from other devices. An example of this might be to calculate the closeness of a user behaviour encoded through embeddings to another user behavior encoded using the same instructions schema.

Although the algorithms described above, including those with reference to the foregoing flow charts, have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application-specific integrated circuit (ASIC), a programmable logic device (PLD), a field-programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine-readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination

What is claimed is:

1. A computer-implemented method for automatically converting distributed raw user data into processable data for data analysis:
generating, at a server, from a data schema comprising one or more data types, an instruction schema comprising, for each data type in said one or more data types, one or more instructions to be applied to the data type;
for each device in a plurality of devices communicatively coupled to said server:
sending, from the server, to the device, the instruction schema;
receiving, at the device, the instruction schema;
applying, at the device, each instruction in the instruction schema on locally stored raw user data, so as to generate an embedding of processable data;
sending, from the device, to the server, the embedding; and
receiving, at said server, the embedding from each device.

2. The method of claim 1, wherein said each instruction comprises one or more additional parameters required to apply the instruction on the data type.

3. The method of claim 2, wherein said applying comprises the steps of:
executing an executable function corresponding to said instruction using the one or more parameters on said locally stored raw user data; and
adding an output of said executable function to the embedding.

4. The method of claim 3, further comprising the step of, before said executing:
identifying, on a memory of the device, the executable function corresponding to the instruction.

5. The method of claim 3, wherein said instruction comprises the executable function to be executed.

6. The method of claim 1, wherein one or more labels are appended to the embedding by the device.

7. The method of claim 1, wherein at least two of said one or more instructions are chain instructions, wherein each of the chain instructions are to be applied in a sequence, and wherein an output of a given chain instruction is used as an input for the next chain instruction in the sequence, and wherein the final chain instruction in the sequence generates the embedding.

8. The method of claim 6, wherein a plurality of embeddings is generated by said chain instructions and wherein the final chain instruction is directed to averaging the corresponding data types in said plurality of embeddings.

9. The method of claim 1, further comprising the step of:
performing, on said server, a data analysis task on the processable data of said received embedding.

10. The method of claim 1, wherein at least some of said instructions are directed to reducing the accuracy of the raw user data so as to render it more difficult to extract private information therefrom.

11. The method of claim 9, wherein said data analysis task comprises a clustering analysis or similarity testing.

12. The method of claim 9, wherein the data analysis task is a machine learning training task.

13. The method of claim 12, wherein the machine learning training task uses at least one of: supervised learning or unsupervised learning.

14. The method of claim 12, wherein the training task is only performed every time a designated number of embeddings are received from the one or more devices.

15. The method of claim 12, wherein a previous training task is resumed upon receiving another embedding.

16. A system for converting raw user data into processable data for data analysis, the system comprising:
a server, the server comprising:
a memory for storing a data schema comprising one or more data types;
a networking module communicatively coupled to a network;
a processor communicatively coupled to said memory and networking module, and operable to generate from the data schema an instruction schema comprising, for each data type in said one or more data types, one or more instructions to be applied to the data type;
a plurality of devices, each comprising a memory, a networking module communicatively coupled to server via said network and a processor communicatively coupled to the memory and networking module, and operable to:
receive, from the server via said network, the instruction schema;
apply each instruction in the instruction schema on raw user data stored on said memory of said device, so as to generate an embedding of processable data; and
send, to the server via said network, the embedding; and
wherein the server is further configured to receive each embedding from the plurality of devices and store it in the memory of the server.

17. The method of claim 16, wherein said each instruction comprises one or more additional parameters required to apply the instruction on the data type.

18. The method of claim 17, wherein each of said plurality of devices are each configured to apply each instruction by:
executing an executable function corresponding to said instruction using the one or more parameters on said raw user data; and
adding an output of said executable function to the embedding.

19. The system of claim 16, wherein said server is further configured to perform a machine learning training task on the processable data of said received embeddings.

20. A non-transitory computer-readable storage medium including instructions that, when processed by a device communicatively coupled to a server via a network, configure the device to perform the steps of:
receiving, from the server via said network, an instruction schema comprising, for each data type in one or more data types of a data schema, one or more instructions to be applied to the data type;
applying each instruction in the instruction schema on locally stored raw user data, so as to generate an embedding of processable data;
sending to the server via said network, the embedding.
